(19) United States
(12) Patent Application Publication
(10) Pub. No.: US 2025/0200724 A1
(43) Pub. Date: Jun. 19, 2025

(54) LOW-ILLUMINATION IMAGE ADAPTIVE ENHANCEMENT METHOD, APPARATUS THEREOF, DEVICE AND STORAGE MEDIUM

(71) Applicant: Nanjing University of Posts and Telecommunications, Nanjing (CN)

(72) Inventors: Dengyin ZHANG, Nanjing (CN); Dichen ZHENG, Nanjing (CN); Jikai HE, Nanjing (CN); Fan GAO, Nanjing (CN)

(21) Appl. No.: 19/031,403

(22) Filed: Jan. 18, 2025

Related U.S. Application Data
(63) Continuation of application No. PCT/CN2025/070533, filed on Jan. 3, 2025.

(30) Foreign Application Priority Data
Jul. 9, 2024 (CN) 202410912479.X

(51) Int. Cl. G06T 5/60; G06T 5/50; G06T 5/70

(52) U.S. Cl. CPC G06T 5/60; G06T 5/50; G06T 5/70; G06T 2207/20004; G06T 2207/20081; G06T 2207/20084

(57) ABSTRACT

Provided is a low-illumination image adaptive enhancement method, an apparatus thereof, a device and a storage medium. The method includes: inputting a low-illumination image to be enhanced into a pre-trained low-illumination image adaptive enhancement model to obtain an enhanced image. A method of training the low-illumination image adaptive enhancement model includes: acquiring a training set containing the low-illumination image and the corresponding reference image; constructing the low-illumination image adaptive enhancement model based on a Retinex algorithm. The low-illumination image adaptive enhancement model includes a projection module, an illumination component module, a reflectance component module and an enhancement module. The training set is used to train the low-illumination image adaptive enhancement model, and the trained low-illumination image adaptive enhancement model is obtained. The brightness and the contrast of the image are enhanced, and at the same time, the color and structure information of the image is restored effectively.

### TECHNICAL FIELD

The present disclosure belongs to the technical field of digital image processing, and in particular, relates to a low-illumination image adaptive enhancement method, an apparatus thereof, a device and a storage medium.

### BACKGROUND

With the development of new media technology, communication media such as voices, images, and videos are attracting more and more attention from the public. An image is one of the most intuitive ways for people to know the world. However, images are usually shot under sub-optimal lighting conditions. Due to environmental factors such as poor lighting and an improper beam angle, as well as technical limitations such as small International Organization for Standardization (ISO) and short exposure time, there are not enough photons reaching a sensor, which often leads to the deteriorated features and the low contrast of the shot images. Such images are referred to as low-illumination images.

The above problems can be solved in a reasonable manner from the camera level, such as using higher ISO and longer exposure time to significantly improve the brightness of the image. However, improving ISO will result in noises in the image, while long-term exposure will result in motion blur, so that the image quality is worse. Another feasible scheme is to use image editing tools such as Photoshop or Lightroom to enhance the visual attraction of low-light images. However, using these image editing tools requires professional knowledge and skills, and usually takes a lot of time.

In addition to improving the image quality on the hardware level, the research on the low-illumination image enhancement algorithm has also become one of the hot spots in the field of image processing. There are mainly two categories of traditional methods. One category of traditional methods is to enhance the brightness and the contrast of images based on histogram equalization, and the other category of traditional methods is to construct a model to enhance images based on a Retinex theory. However, these methods usually have their limitations, such as the detail loss and the color distortion of the enhanced results due to too ideal assumptions, the difficulty in finding accurate priors, and long operating time due to the complex optimization process. In recent years, thanks to the rapid development of deep learning, some pioneering work on low-light image enhancement has achieved remarkable results. Compared with the traditional methods, the solution based on deep learning has better accuracy, robustness and calculation speed, which has attracted more and more attention.

A low-illumination image not only reduces the perceived quality of the image, but also affects the performance of a series of subsequent advanced visual tasks, including image recognition, object detection and semantic segmentation. Therefore, it is of great research significance and application value to enhance the low-quality image in a low-illumination environment. However, most of the existing low-illumination image enhancement methods based on deep learning are based on supervised learning, which usually have a complex network structure and relay on a large number of parameters. A few methods based on unsupervised learning cannot solve the problems of poor brightness, color distortion and serious noises at the same time. How to realize lightweight and efficient low-illumination image enhancement method based on deep learning is still a big challenge.

Therefore, the existing low-illumination image enhancement methods based on deep learning have a complex network structure and relay on a large number of parameters, and it is difficult to effectively deal with the problems of poor brightness, color distortion and serious noises.

### SUMMARY

The purpose of the present disclosure is to overcome the shortcomings in the prior art, and provide a low-illumination image adaptive enhancement method, an apparatus thereof, a device and a storage medium. In view of the fact that noises are not taken into account when the Retinex model decomposes images in an ideal state, a projection module is designed, and unsuitable noises and features are removed through paired low-illumination images. The low-illumination image is decomposed into an illumination component and a reflectance component by using L-Net and R-Net which only contain several convolution layers, residual connection and a channel attention mechanism. A lightweight adaptive adjustment curve cooperates with a joint loss function consisted of a non-reference loss function and a reference loss function to gradually enhance the brightness and the contrast of the image, and at the same time, effectively restore the color and structure information of the image.

In order to achieve the above purpose, the present disclosure is realized by using the following technical scheme.

In a first aspect, the present disclosure provides a low-illumination image adaptive enhancement method, including:
inputting a low-illumination image to be enhanced into a pre-trained low-illumination image adaptive enhancement model to obtain an enhanced image;
wherein a method of training the low-illumination image adaptive enhancement model includes:
acquiring a training set containing the low-illumination image and the corresponding reference image;
constructing the low-illumination image adaptive enhancement model based on a Retinex algorithm; wherein the low-illumination image adaptive enhancement model includes a projection module, an illumination component module, a reflectance component module and an enhancement module;
using the training set to train the low-illumination image adaptive enhancement model, and obtaining the trained low-illumination image adaptive enhancement model.

Further, the projection module includes five 3×3 convolution layers; wherein the first four convolution layers use a Rectified Linear Unit (ReLU) function as an activation function, the output of a fifth convolution layer is residually connected with an input image of the projection module, and the projection module ends with a Sigmoid function;
the illumination component module includes five 3×3 convolution layers; wherein the first four convolution layers use a ReLU function as an activation function, the output of a fifth convolution layer is residually connected with an input image of the illumination component module, and the illumination component module ends with a Sigmoid function;
the reflectance component module includes five 3×3 convolution layers and a channel attention module; wherein the first four convolution layers use a ReLU function as an activation function, the output of a fifth convolution layer is input into the channel attention module to be residually connected with an input image of the reflectance component module, and the reflectance component module ends with a Sigmoid function; and the channel attention module includes global average pooling and two 1×1 convolution layers;
the enhancement module includes seven depth separable convolution layers; wherein the input of a fifth convolution layer is the splicing of the outputs of a third convolution layer and a fourth convolution layer, the input of a sixth convolution layer is the splicing of the outputs of the fifth convolution layer and a second convolution layer, and the input of a seventh convolution layer is the splicing of the outputs of the sixth convolution layer and a first convolution layer; the first six convolution layers use a ReLu function as an activation function, and a seventh convolution layer uses a tanh function as an activation function.

Further, using the training set to train the low-illumination image adaptive enhancement model includes:
inputting low-illumination image pairs I1 and I2 into the projection module to obtain projection image pairs i1 and i2;
inputting the projection image pairs i1 and i2 into the illumination component module and the reflectance component module for decomposition to obtain illumination components L1 and L2 and reflectance components R1 and R2;
inputting the illumination component L1 into an enhanced network to obtain the illumination component enhanced_L enhanced by an adaptive adjustment curve;
multiplying the illumination component enhanced_L enhanced by the adaptive adjustment curve by the reflectance component R1 element by element to obtain an enhanced image E.

Further, the low-illumination images and the corresponding reference image are low-illumination image pairs of the same scene with insufficient exposure but different exposure degrees and corresponding normally exposed reference images, which are acquired from a Single Image Contrast Enhancement (SICE) public data set and a Low-Light (LOL) public data set.

Further, inputting low-illumination image pairs I1 and I2 into the projection module to obtain projection image pairs i1 and i2 includes:
inputting the low-illumination image pairs I1 and I2 into the projection module, removing noises and features unsuitable for Retinex decomposition, and obtaining optimized low-illumination images as the projection image pairs i1 and i2;
wherein a projection loss function L_{P} is used to remove noises and features unsuitable for Retinex decomposition, and the projection loss function L_{P} is:

$${L}_{p} = {‖ {I}_{1} - {i}_{1} ‖}_{2}^{2}$$

where I₁ denotes a low-illumination image, and i₁ denotes a projected image;
inputting the projection image pairs i1 and i2 into the illumination component module and the reflectance component module for decomposition to obtain illumination components L1 and L2 and reflectance components R1 and R2 includes:
decomposing the projection image by the loss function L_{R} consisted of a reflectance consistency loss L_{C} and a basic constraint;
where L_{C} and L_{R} are expressed as:

$${L}_{C} = {‖ {R}_{1} - {R}_{2} ‖}_{2}^{2} \\ {L}_{R} = {‖ R \cdot L - i ‖}_{2}^{2} + {‖ R - i / stopgrad ( L ) ‖}_{2}^{2} - {‖ L - {L}_{0} ‖}_{2}^{2} + {‖ ∇ L ‖}_{1}$$

where L denotes an illumination component, R denotes a reflectance component, i denotes a projection image; R₁ and R₂ denote reflectance components of the low-illumination image pairs; L₀ denotes an initial estimate of the illumination component, which is acquired by calculating the maximum values of R, G and B channels; ∇ denotes horizontal and vertical gradients; stopgrad(L) means that network training spreads no gradient information to the illumination components during calculation;
the loss function of the step is expressed as:

$${L}_{stage 1} = {ω}_{0} {L}_{P} + {ω}_{1} {L}_{C} + {ω}_{2} {L}_{R}$$

where ω₀, ω₁ and ω₂ are weighted weights.

Further, inputting the illumination component L1 into an enhanced network to obtain the illumination component enhanced_L enhanced by an adaptive adjustment curve includes:
using the adaptive adjustment curve to iteratively enhance the illumination component; wherein the adaptive adjustment curve is expressed as:

$${LE}_{n} ( x ) = {LE}_{n - 1} ( x ) + {A}_{n} ( x ) {LE}_{n - 1} ( x ) ( 1 - {LE}_{n - 1} ( x ) )$$

where Aₙ(x) is a parameter map with the same size as the given image that is capable of being learned by the enhanced network in the adaptive adjustment curve, and LEₙ₋₁(x) is the previous enhanced image in all iterations of the network.

Further, for the luminance component enhanced_L enhanced by the adaptive adjustment curve, the loss function of the step is expressed as:

$${L}_{stage 2} = {L}_{1} + {L}_{SSIM} + {L}_{col} + {L}_{bri} + {L}_{stru}$$

where L₁ denotes an average absolute error, L_{SSIM} denotes a structural similarity loss between the enhanced image E and the reference image H, L_{col}, L_{bri} and Lₛₜᵣᵤ denote a color loss, a brightness loss and a structural loss, respectively;
the color loss L_{col} is expressed as:

$${L}_{col} = 1 - {\sum }_{x = 1 , y = 1}^{u , v} 〈 {E}_{( x , y )} , {H}_{( x , y )} 〉$$

the brightness loss L_{bri} is expressed as:

$${L}_{bir} = 1 - {\sum }_{c ∈ R , G , B} {\sum }_{x = 1 , y = 1}^{u , y} 〈 b ( {E}_{( x , y )}^{c} ) - min ( b ( {E}_{( x , y )}^{c} ) ) , b ( {H}_{( x , y )}^{c} ) - min ( b ( {H}_{( c , y )}^{c} ) ) 〉$$

the structural loss Lₛₜᵣᵤ is expressed as:

$${L}_{stru} = 1 - {\sum }_{c ∈ R , G , B} {\sum }_{x = 1 , y = 1}^{u , v} 〈 b ( ∇ {E}_{( x , y )}^{c} ) - min ( b ( ∇ {E}_{( x , y )}^{c} ) ) , b ( ∇ {H}_{( x , y )}^{c} ) - min ( b ( ∇ {H}_{( x , y )}^{c} ) ) 〉$$

where E_{(x,y)} and H_{(x,y)} denote pixel vectors of an x-th row and a y-th column of the enhanced image and the reference image, respectively, u and v denote that there are u rows and v columns of images, [symbol] • [symbol] denotes the cosine similarity of the two vectors; c denotes three color channels of R, G and B, b(E_{(x,y)}^{c}) and b(H_{(x,y)}^{c}) denote pixel blocks with pixels E_{(x,y)}^{c} and H_{(x,y)}^{c} as the center.

In a second aspect, the present disclosure provides a low-illumination image adaptive enhancement apparatus, including:
an enhancement module, which is configured to input a low-illumination image to be enhanced into a pre-trained low-illumination image adaptive enhancement model to obtain an enhanced image;
wherein a method of training the low-illumination image adaptive enhancement model includes:
acquiring a training set containing the low-illumination image and the corresponding reference image;
constructing the low-illumination image adaptive enhancement model based on a Retinex algorithm; wherein the low-illumination image adaptive enhancement model includes a projection module, an illumination component module, a reflectance component module and an enhancement module;
using the training set to train the low-illumination image adaptive enhancement model, and obtaining the trained low-illumination image adaptive enhancement model.

In a third aspect, the present disclosure provides a computer device, including a processor and a storage medium;
wherein the storage medium is configured to store instructions;
the processor is configured to operate according to the instructions to implement the steps of the low-illumination image adaptive enhancement method according to the first aspect.

In a fourth aspect, the present disclosure provides a computer-readable storage medium, on which a computer program is stored, wherein the computer program, when executed by a processor, implements the low-illumination image adaptive enhancement method according to the first aspect.

Compared with the prior art, the present disclosure has the following beneficial effects.

(1) According to the present disclosure, in view of the fact that noises are not taken into account when the Retinex model decomposes images in an ideal state, a projection module is designed, and unsuitable noises and features are removed through paired low-illumination images.

(2) Based on the Retinex theory, the present disclosure designs a lightweight decomposition model. The low-illumination image is decomposed into an illumination component and a reflectance component by using L-Net and R-Net which only contain several convolution layers, residual connection and a channel attention mechanism. The network parameters are small, and the complexity of the network structure is significantly reduced.

(3) According to the present disclosure, a lightweight adaptive adjustment curve cooperates with a joint loss function consisted of a non-reference loss function and a reference loss function to gradually enhance the brightness and the contrast of the image, and at the same time, effectively restore the color and structure information of the image, which has obvious advantages in objective evaluation indexes of the image quality such as a Peak Signal-To-Noise Ratio (PSNR) and a Structural Similarity (SSIM).

### BRIEF DESCRIPTION OF THE DRAWINGS

FIG. 1 shows an overall flow diagram of a lightweight low-illumination image adaptive enhancement method based on Retinex according to an example of the present disclosure.

FIG. 2 shows a schematic flow chart of a projection and decomposition network according at a first stage to an example of the present disclosure.

FIG. 3 shows a schematic flow chart of an enhanced network at a second stage according to an example of the present disclosure.

FIG. 4 shows a schematic diagram of an original low-illumination image for testing according to an example of the present disclosure.

FIG. 5 shows a schematic diagram of experimental results obtained according to a lightweight low-illumination image enhancement method according to an example of the present disclosure.

### DETAILED DESCRIPTION OF THE EMBODIMENTS

The technical concept of the present disclosure is as follows. In view of the fact that noises are not taken into account when the Retinex model decomposes images in an ideal state, a projection module is designed, and unsuitable noises and features are removed through paired low-illumination images. The low-illumination image is decomposed into an illumination component and a reflectance component by using L-Net and R-Net which only contain several convolution layers, residual connection and a channel attention mechanism. A lightweight adaptive adjustment curve cooperates with a joint loss function consisted of a non-reference loss function and a reference loss function to gradually enhance the brightness and the contrast of the image, and at the same time, effectively restore the color and structure information of the image.

The technical scheme in the embodiment of the present disclosure will be clearly and completely described with reference to the drawings in the embodiment of the present disclosure hereinafter. Obviously, the described embodiment are only some embodiment of the present disclosure, rather than all of the embodiments. The following description of at least one exemplary embodiment is merely illustrative in nature and is in no way intended to limit the present disclosure, its application or uses.

### Embodiment 1

The embodiment provides low-illumination image adaptive enhancement method, including:
inputting a low-illumination image into a pre-trained low-illumination image adaptive enhancement model to obtain an enhanced image.

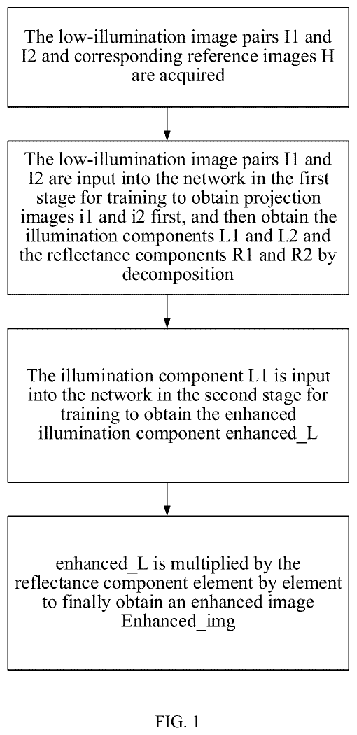

A method of training the low-illumination image adaptive enhancement model, as shown in FIG. 1, includes the following steps.

Step S1, two low-illumination image pairs I1 and I2 of the same scene with insufficient exposure but different exposure degrees and corresponding normally exposed reference images H are acquired.

Step S2, in the first stage, the low-illumination image pairs I1 and I2 are input into the projection module, which is abbreviated as P-Net. Noises and features unsuitable for Retinex decomposition are removed to generate two optimized low-illumination image pairs i1 and i2.

Step S3, the optimized low-illumination image pairs i1 and i2 are input into the illumination module which is abbreviated as L-Net and the reflectance module which is abbreviated as R-Net based on Retinex theory for decomposition. The illumination components L1 and L2 are obtained by L-Net decomposition, and the reflectance components R1 and R2 are obtained by R-Net decomposition.

Step S4, in the second stage, the L1 component decomposed in the first stage is input into the enhanced network (Enhance-Net), which is abbreviated as E-Net, to obtain the illumination component enhanced_L enhanced by an adaptive adjustment curve.

Step S5, enhanced_L is multiplied by R1 element by element to finally obtain an enhanced image Enhanced_img, which is abbreviated as E.

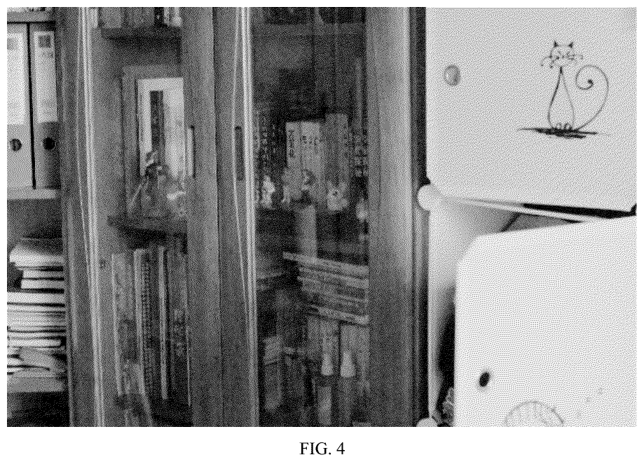

In the embodiment, the low-illumination image pairs of the same scene with insufficient exposure but different exposure degrees and corresponding normally exposed reference images in Step S1 are collected from a Single Image Contrast Enhancement (SICE) public data set and a Low-Light (LOL) public data set. The LOL data set is the first paired image data set containing low light and normal light shot in a real scene. The SICE data set also consists of low-light and normal-light image pairs, including multiple-exposure image sequences in the indoor and outdoor scenes. Each sequence contains 3 to 18 low-contrast images with different exposure degrees. Two normally exposed reference images in the data set and several corresponding underexposed and well-aligned low-illumination images are selected randomly to construct a training set. Each normally exposed reference image in the constructed training set contains 2 to 6 underexposed low-illumination images. As shown in FIG. 4, the embodiment is used for testing the original low-illumination image.

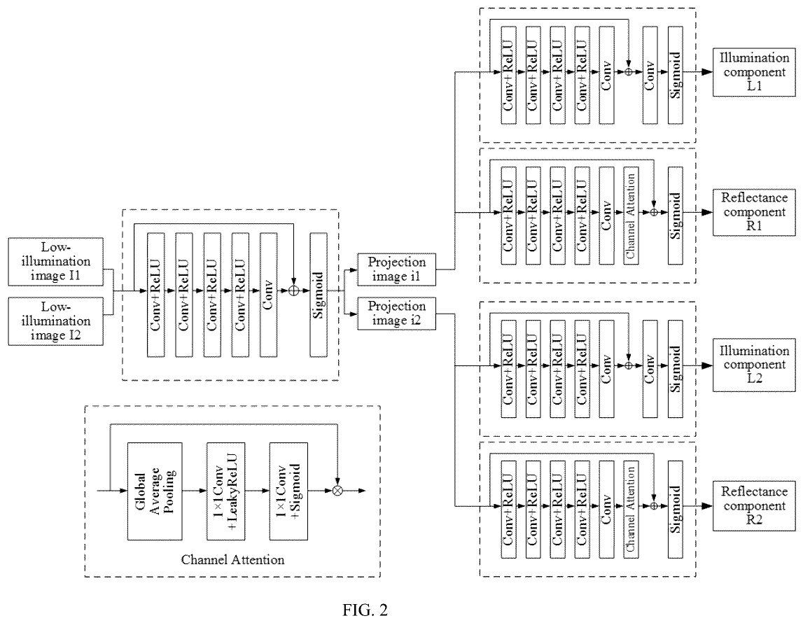

In the embodiment, Step S2 and Step S3 refer to the flow chart of the projection and decomposition network in the first stage shown in FIG. 2. In Step S2, the P-Net only consists of five 3×3 convolution layers. The first four convolution layers use a ReLU function as an activation function, and the output of a fifth convolution layer is residually connected with an input image input into the P-Net, which reduces the gradient dissipation and improves the network performance. P-Net ends with a Sigmoid layer and standardizes the output to [0,1]. The projection loss function L_{P} is used to guide P-Net to remove unsuitable noises and features. The projection loss function L_{P} is:

$${L}_{p} = {‖ {I}_{1} - {i}_{1} ‖}_{2}^{2}$$

where i₁ denotes a projected image. Unsuitable noises in the original low-illumination image are removed after being projected.

In the embodiment, the L-Net in Step S3 is used to decompose the illumination component of the low-illumination image, and mainly consists of five 3×3 convolution layers. The first four convolution layers use a ReLU function as an activation function, and the output of a fifth convolution layer is residually connected with the input image input into L-Net, which reduces the gradient dissipation and improves the network performance. According to the Retinex theory, it is assumed that three color channels have the same illumination component, so that L-Net uses a sixth convolution layer to convert the number of channels of the output results into 1. L-Net ends with a Sigmoid layer and standardizes the output to [0,1]. R-Net is used to decompose the reflectance component of the low-illumination images, which mainly consists of five 3×3 convolution layers and a channel attention module. The first four convolution layers use a ReLU function as an activation function, and the output of a fifth convolution layer is input into the channel attention module to be residually connected with an input image input into R-Net, which reduces the gradient dissipation and improves the network performance. R-Net ends with a Sigmoid layer and standardizes the output to [0,1].

The channel attention module only uses global average pooling and two 1×1 convolution layers. The module infers an attention map along the channel dimension and multiplies the attention map by the feature map to generate a weighted feature map, which can be used for cross-channel information interaction.

The L-Net and R-Net decompose the low-illumination image through a loss function L_{R} consisted of a reflectance consistency loss L_{C} and some basic constraints of the Retinex theory. L_{C} and L_{R} can be expressed as:

$${L}_{C} = {‖ {R}_{1} - {R}_{2} ‖}_{2}^{2} \\ {L}_{R} = {‖ R \cdot L - i ‖}_{2}^{2} + {‖ R - i / stopgrad ( L ) ‖}_{2}^{2} + {‖ L - {L}_{0} ‖}_{2}^{2} + {‖ ∇ L ‖}_{1}$$

where R₁ and R₂ denote reflectance components of the low-illumination image pairs, i denotes a projected image, L₀ denotes an initial estimate of the illumination component, which is acquired by calculating the maximum values of R, G and B channels, and ∇ denotes horizontal and vertical gradients.

The overall loss function of the first stage described by Step S2 and Step S3 can be expressed by the weights ω₀, ω₁ and ω₂ as:

$${L}_{stage 1} = {ω}_{0} {L}_{P} + {ω}_{1} {L}_{C} + {ω}_{2} {L}_{R}$$

where the weights ω₀, ω₁ and ω₂ are 100, 1, and 1, respectively, in the embodiment.

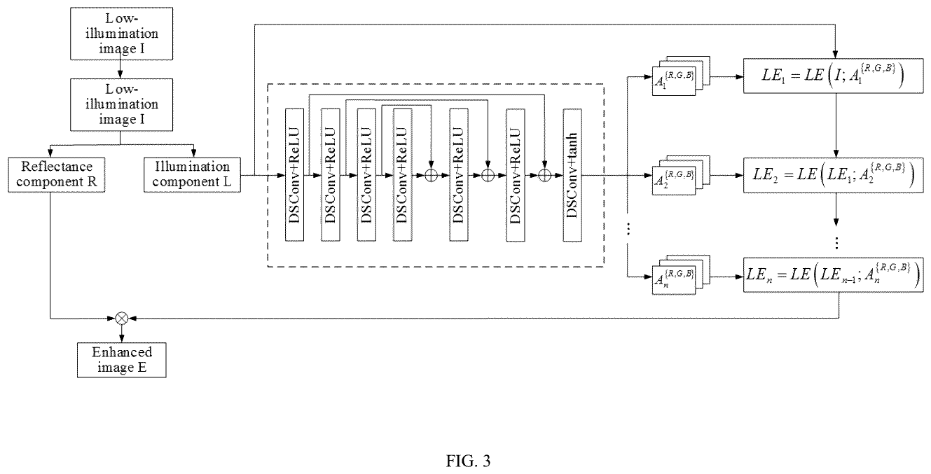

In the embodiment, Step S4 refers to the flow chart of an enhanced network in the second stage in FIG. 3. The adaptive adjustment curve for iterative enhancement in Step S4 can be expressed as:

$${LE}_{n} ( x ) = {LE}_{n - 1} ( x ) + {A}_{n} ( x ) {LE}_{n - 1} ( x ) ( 1 - {LE}_{n - 1} ( x ) )$$

where Aₙ(x) is a parameter map with the same size as the given image that is capable of being learned by the enhanced network in the adaptive adjustment curve, and LEₙ₋₁(x) is the previous enhanced image in all iterations of the network. The enhanced network E-Net contains seven depth separable convolution layers. The input image passes through the first four convolution layers in sequence. The input of a fifth convolution layer is the splicing of the outputs of a third convolution layer and a fourth convolution layer. The input of a sixth convolution layer is the splicing of the outputs of the fifth convolution layer and a second convolution layer. The input of a seventh convolution layer is the splicing of the outputs of the sixth convolution layer and a first convolution layer. The first six convolution layers use a ReLu function as an activation function after each convolution layer, and a seventh convolution layer uses a tanh function as an activation function after convolution. The output of the seventh convolution layer is used as the parameter map Aₙ(x) of the adaptive adjustment curve, and enhanced_L is obtained by adaptively enhancing the illumination component according to the curve.

In the embodiment, Step S5 can obtain the final enhanced image E according to the outputs of the two stages. The weight of each loss item of the loss function in the second stage is 1, which can be expressed as:

$${L}_{stage 2} = {L}_{1} + {L}_{SSIM} + {L}_{col} + {L}_{bri} + {L}_{stru}$$

where L₁ denotes an average absolute error, L_{SSIM} denotes a structural similarity loss between the enhanced image E and the reference image H, L_{col}, L_{bri} and Lₛₜᵣᵤ denote a color loss, a brightness loss and a structural loss, respectively.

The color loss L_{col} can be expressed as:

$${L}_{col} = 1 - {\sum }_{x = 1 , y = 1}^{u , v} 〈 {E}_{( x , y )} , {H}_{( x , y )} 〉$$

where E_{(x,y)} and H_{(x,y)} denote pixel vectors of an x-th row and a y-th column of the enhanced image and the reference image, respectively, u and v denote that there are u rows and v columns of images, [symbol] • [symbol] denotes the cosine similarity of the two vectors.

The brightness loss L_{bri} can be expressed as:

$${L}_{bri} = 1 - {\sum }_{c ∈ R , G , B} {\sum }_{x = 1 , y = 1}^{u , v} 〈 b ( {E}_{( x , y )}^{c} ) - min ( b ( {E}_{( x , y )}^{c} ) ) , b ( {H}_{( x , y )}^{c} ) - min ( b ( {H}_{( x , y )}^{c} ) ) 〉$$

where c denotes three color channels of R, G and B, b(E_{(x,y)}^{c}) and b(H_{(x,y)}^{c}) denote pixel blocks with pixels E_{(x,y)}^{c} and H_{(x,y)}^{c} as the center.

The structural loss Lₛₜᵣᵤ can be expressed as:

$${L}_{stru} = 1 - {\sum }_{c ∈ R , G , B} {\sum }_{x = 1 , y = 1}^{u , v} 〈 b ( ∇ {E}_{( x , y )}^{c} ) - min ( b ( ∇ {E}_{( x , y )}^{c} ) ) , b ( ∇ {H}_{( x , y )}^{c} ) - min ( b ( ∇ {H}_{( x , y )}^{c} ) ) 〉$$

In the embodiment, the Pytorch deep learning framework and two Nvidia Geforce GTX 1660Ti GPU are used to train the network. The low-illumination image pair and the corresponding reference image collected in Step S1 are input into the network model in the first stage and the second stage in sequence. In the first stage, the input low-illumination image pair is randomly cropped to the size of 128×128 pixels. The training batch size is 8. The Adam optimizer with an initial learning rate of 1×10⁻⁴ is used to train the network, and the number of training iterations is set to 300 times. In the second stage, the low-illumination image and the reference image are input as the image pairs for training. The low-illumination image is decomposed into an illumination component and a reflectance component through the trained network in the first stage. The illumination component is input into the enhanced network in the second stage for enhancement and is multiplied by the reflectance component element by element to obtain the final enhanced image. The training batch size is 8. The Adam optimizer with an initial learning rate of 1×10⁻⁴ is used to train the network, and the number of training iterations is set to 300 times.

In order to compare the experimental results of the embodiment with the advanced low-light image enhancement methods in recent stages, the widely used evaluation indexes, that is, a Peak Signal-To-Noise Ratio (PSNR) and a Structural Similarity (SSIM), are used to quantitatively evaluate the experimental results.

The Peak Signal-To-Noise Ratio (PSNR) can be expressed as:

$$MSE = \frac{1}{H \cdot W} {\sum }_{x = 0}^{H - 1} {\sum }_{y = 0}^{W - 1} {[ X ( x , y ) - Y ( x , y ) ]}^{2} \\ PSNR = 10 \cdot {log}_{10} ( \frac{{MAX}_{X}^{2}}{MSE} )$$

where MSE denotes a mean square error of images X and Y, H and W denote the length and the width of the images, respectively, and MAX_{X} denotes the maximum pixel value of image X. The larger the PSNR value, the better the image quality.

The Structural Similarity (SSIM) can be expressed as:

$$SSIM = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )}$$

where μₓ and μ_{y} denote mean values of images X and Y, σₓ² and σ_{y}² denote variances of images X and Y, respectively, σ_{xy} denotes a covariance, c₁ and c₂ are non-zero constants. The value range of the SSIM is [0,1], and the closer to 1, the higher the similarity between images X and Y.

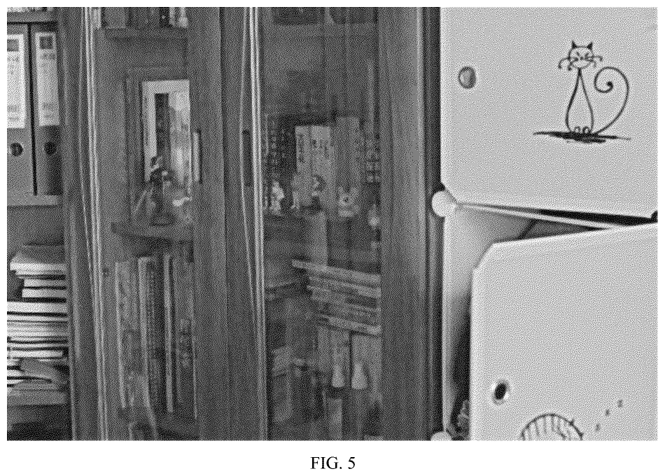

The experimental results obtained according to the lightweight low-illumination image enhancement method provided by the example of the present disclosure are shown in FIG. 5. The experimental results of the embodiment are compared with the advanced low-illumination image enhancement methods in recent five years on the test set of the Low-Light (LOL) data set, and the results are shown in Table 1. Bold fonts in the table indicate the optimal results, and underlined fonts indicate the suboptimal results. The lightweight low-illumination image enhancement method provided by the embodiment has a small number of network parameters and a simple network structure, and has achieved good evaluation indexes.

TABLE 1
Evaluation indexes of different algorithms on the LOL test set

| Algorithm | PSNR | SSIM |
|---|---|---|
| LIME-2017 | 16.76 | 0.445 |
| EnlightenGAN-2019 | 17.48 | 0.651 |
| Zero-DCE-2020 | 14.86 | 0.562 |
| DRBN-2020 | 16.29 | 0.551 |
| RRDNet-2020 | 11.39 | 0.468 |
| RUAS-2021 | 18.03 | 0.697 |
| SCI-2022 | 14.78 | 0.522 |
| PairLIE-2023 | 18.74 | 0.716 |
| Self-DACE-2023 | 19.15 | 0.724 |
| FLW-Net-2023 | 22.84 | 0.83 |
| Ours | 19.98 | 0.763 |

### Embodiment 2

The embodiment provides a low-illumination image adaptive enhancement apparatus, including:
an enhancement module, which is configured to input a low-illumination image to be enhanced into a pre-trained low-illumination image adaptive enhancement model to obtain an enhanced image;
wherein a method of training the low-illumination image adaptive enhancement model includes:
acquiring a training set containing the low-illumination image and the corresponding reference image;
constructing the low-illumination image adaptive enhancement model based on a Retinex algorithm; wherein the low-illumination image adaptive enhancement model includes a projection module, an illumination component module, a reflectance component module and an enhancement module;
using the training set to train the low-illumination image adaptive enhancement model, and obtaining the trained low-illumination image adaptive enhancement model.

### Embodiment 3

The embodiment provides a computer device, including a processor and a storage medium;
wherein the storage medium is configured to store instructions;
the processor is configured to operate according to the instructions to implement the steps of the low-illumination image adaptive enhancement method according to the first aspect.

### Embodiment 4

In a fourth aspect, the present embodiment provides a computer-readable storage medium, on which a computer program is stored, wherein the computer program, when executed by a processor, implements the low-illumination image adaptive enhancement method according to the first aspect.

It should be understood by those skilled in the art that the embodiment of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure can take the form of a computer program product implemented on one or more computer-usable storage media (including but not limited to a disk storage, a CD-ROM, an optical storage, etc.) containing computer-usable program codes.

The present disclosure is described with reference to flow charts and/or block diagrams of a method, a device (a system), and a computer program product according to the embodiment of the present disclosure. It should be understood that each flow and/or block in the flow chart and/or block diagram, and combinations of the flows and/or blocks in the flow chart and/or block diagram can be implemented by computer program instructions. These computer program instructions may be provided to a processor of a general-purpose computer, a special-purpose computer, an embedded processor or other programmable data processing devices to produce a machine, so that the instructions which are executed by the processor of the computer or other programmable data processing devices produce an apparatus for implementing the functions specified in one or more flows in the flow chart and/or one or more blocks in the block diagram.

These computer program instructions may also be stored in a computer-readable memory that can direct a computer or other programmable data processing devices to function in a particular manner, so that the instructions stored in the computer-readable memory produce an article of manufacture including an instruction apparatus. The instruction apparatus implements the functions specified in one or more flows in the flow chart and/or one or more blocks in the block diagram.

These computer program instructions may also be loaded onto a computer or other programmable data processing devices, so that a series of operation steps are performed on the computer or other programmable devices to produce a computer-implemented process, so that the instructions executed on the computer or other programmable devices provide steps for implementing the functions specified in one or more flows in the flow chart and/or one or more blocks in the block diagram.

The above is only the preferred embodiment of the present disclosure. It should be pointed out that those skilled in the art can make several improvements and variations without departing from the technical principles of the present disclosure, and these improvements and variations should also be regarded as the scope of protection of the present disclosure.

What is claimed is:

1. A low-illumination image adaptive enhancement method, comprising:
inputting a low-illumination image to be enhanced into a pre-trained low-illumination image adaptive enhancement model to obtain an enhanced image;
wherein a method of training the low-illumination image adaptive enhancement model includes:
acquiring a training set containing the low-illumination image and the corresponding reference image;
constructing the low-illumination image adaptive enhancement model based on a Retinex algorithm; wherein the low-illumination image adaptive enhancement model includes a projection module, an illumination component module, a reflectance component module and an enhancement module;
using the training set to train the low-illumination image adaptive enhancement model, and obtaining the trained low-illumination image adaptive enhancement model.

2. The low-illumination image adaptive enhancement method according to claim 1, wherein
the projection module comprises five 3×3 convolution layers; wherein the first four convolution layers use a Rectified Linear Unit (ReLU) function as an activation function, the output of a fifth convolution layer is residually connected with an input image of the projection module, and the projection module ends with a Sigmoid function;
the illumination component module comprises five 3×3 convolution layers; wherein the first four convolution layers use a ReLU function as an activation function, the output of a fifth convolution layer is residually connected with an input image of the illumination component module, and the illumination component module ends with a Sigmoid function;
the reflectance component module comprises five 3×3 convolution layers and a channel attention module; wherein the first four convolution layers use a ReLU function as an activation function, the output of a fifth convolution layer is input into the channel attention module to be residually connected with an input image of the reflectance component module, and the reflectance component module ends with a Sigmoid function; and the channel attention module comprises global average pooling and two 1×1 convolution layers;
the enhancement module comprises seven depth separable convolution layers; wherein the input of a fifth convolution layer is the splicing of the outputs of a third convolution layer and a fourth convolution layer, the input of a sixth convolution layer is the splicing of the outputs of the fifth convolution layer and a second convolution layer, and the input of a seventh convolution layer is the splicing of the outputs of the sixth convolution layer and a first convolution layer; the first six convolution layers use a ReLu function as an activation function, and a seventh convolution layer uses a tanh function as an activation function.

3. The low-illumination image adaptive enhancement method according to claim 1, wherein using the training set to train the low-illumination image adaptive enhancement model comprises:
inputting low-illumination image pairs I1 and I2 into the projection module to obtain projection image pairs i1 and i2;
inputting the projection image pairs i1 and i2 into the illumination component module and the reflectance component module for decomposition to obtain illumination components L1 and L2 and reflectance components R1 and R2;
inputting the illumination component L1 into an enhanced network to obtain the illumination component enhanced_L enhanced by an adaptive adjustment curve;
multiplying the illumination component enhanced_L enhanced by the adaptive adjustment curve by the reflectance component R1 element by element to obtain an enhanced image E.

4. The low-illumination image adaptive enhancement method according to claim 1, wherein
the low-illumination images and the corresponding reference image are low-illumination image pairs of the same scene with insufficient exposure but different exposure degrees and corresponding normally exposed reference images, which are acquired from a Single Image Contrast Enhancement (SICE) public data set and a Low-Light (LOL) public data set.

5. The low-illumination image adaptive enhancement method according to claim 3, wherein
inputting low-illumination image pairs I1 and I2 into the projection module to obtain projection image pairs i1 and i2 comprises:
inputting the low-illumination image pairs I1 and I2 into the projection module, removing noises and features unsuitable for Retinex decomposition, and obtaining optimized low-illumination images as the projection image pairs i1 and i2;
wherein a projection loss function L_{P} is used to remove noises and features unsuitable for Retinex decomposition, and the projection loss function L_{P} is:
$${L}_{p} = {‖ {I}_{1} - {i}_{1} ‖}_{2}^{2}$$
where I₁ denotes a low-illumination image, and i₁ denotes a projected image;
inputting the projection image pairs i1 and i2 into the illumination component module and the reflectance component module for decomposition to obtain illumination components L1 and L2 and reflectance components R1 and R2 comprises:
decomposing the projection image by the loss function L_{R} consisted of a reflectance consistency loss L_{C} and a basic constraint;
where L_{C} and L_{R} are expressed as:
$${L}_{C} = {‖ {R}_{1} - {R}_{2} ‖}_{2}^{2} \\ {L}_{R} = {‖ R \cdot L - i ‖}_{2}^{2} + {‖ R - i / stopgrad ( L ) ‖}_{2}^{2} + {‖ L - {L}_{0} ‖}_{2}^{2} + {‖ ∇ L ‖}_{1}$$
where L denotes an illumination component, R denotes a reflectance component, i denotes a projection image; R₁ and R₂ denote reflectance components of the low-illumination image pairs; L₀ denotes an initial estimate of the illumination component, which is acquired by calculating the maximum values of R, G and B channels; ∇ denotes horizontal and vertical gradients; stopgrad(L) means that network training spreads no gradient information to the illumination components during calculation;
the loss function of the step is expressed as:
$${L}_{stage 1} = {ω}_{0} {L}_{P} + {ω}_{1} {L}_{C} + {ω}_{2} {L}_{R}$$
where ω₀, ω₁ and ω₂ are weighted weights.

6. The low-illumination image adaptive enhancement method according to claim 3, wherein
inputting the illumination component L1 into an enhanced network to obtain the illumination component enhanced_L enhanced by an adaptive adjustment curve comprises:
using the adaptive adjustment curve to iteratively enhance the illumination component;
wherein the adaptive adjustment curve is expressed as:
$${LE}_{n} ( x ) = {LE}_{n - 1} ( x ) + {A}_{n} ( x ) {LE}_{n - 1} ( x ) ( 1 - {LE}_{n - 1} ( x ) )$$
where Aₙ(x) is a parameter map with the same size as the given image that is capable of being learned by the enhanced network in the adaptive adjustment curve, and LEₙ₋₁(x) is the previous enhanced image in all iterations of the network.

7. The low-illumination image adaptive enhancement method according to claim 6, wherein
for the luminance component enhanced_L enhanced by the adaptive adjustment curve, the loss function of the step is expressed as:
$${L}_{stage 2} = {L}_{1} + {L}_{SSIM} + {L}_{col} + {L}_{bri} + {L}_{stru}$$
where L₁ denotes an average absolute error, L_{SSIM} denotes a structural similarity loss between the enhanced image E and the reference image H, L_{col}, L_{bri} and Lₛₜᵣᵤ denote a color loss, a brightness loss and a structural loss, respectively;
the color loss L_{col} is expressed as:
$${L}_{col} = 1 - {\sum }_{x = 1 , y = 1}^{u , v} 〈 {E}_{( x , y )} , {H}_{( x , y )} 〉$$
the brightness loss L_{bri} is expressed as:
$${L}_{bri} = 1 - {\sum }_{c ∈ R , G , B} {\sum }_{x = 1 , y = 1}^{u , v} 〈 b ( {E}_{( x , y )}^{c} ) - min ( b ( {E}_{( x , y )}^{c} ) ) , b ( {H}_{( x , y )}^{c} ) - min ( b ( {H}_{( x , y )}^{c} ) ) 〉$$
the structural loss Lₛₜᵣᵤ is expressed as:
$${L}_{stru} = 1 - {\sum }_{c ∈ R , G , B} {\sum }_{x = 1 , y = 1}^{u , v} 〈 b ( ∇ {E}_{( x , y )}^{c} ) - min ( b ( ∇ {E}_{( x , y )}^{c} ) ) , b ( ∇ {H}_{( x , y )}^{c} ) - min ( b ( ∇ {H}_{( x , y )}^{c} ) ) 〉$$
where E_{(x,y)} and H_{(x,y)} denote pixel vectors of an x-th row and a y-th column of the enhanced image and the reference image, respectively, u and v denote that there are u rows and v columns of images, [symbol] • [symbol] denotes the cosine similarity of the two vectors; c denotes three color channels of R, G and B, b(E_{(x,y)}^{c}) and b(H_{(x,y)}^{c}) denote pixel blocks with pixels E_{(x,y)}^{c} and H_{(x,y)}^{c} as the center.

8. A low-illumination image adaptive enhancement apparatus, comprising:
an enhancement module, which is configured to input a low-illumination image to be enhanced into a pre-trained low-illumination image adaptive enhancement model to obtain an enhanced image;
wherein a method of training the low-illumination image adaptive enhancement model includes:
acquiring a training set containing the low-illumination image and the corresponding reference image;
constructing the low-illumination image adaptive enhancement model based on a Retinex algorithm; wherein the low-illumination image adaptive enhancement model includes a projection module, an illumination component module, a reflectance component module and an enhancement module;
using the training set to train the low-illumination image adaptive enhancement model, and obtaining the trained low-illumination image adaptive enhancement model.

9. A computer device, comprising a processor and a storage medium;
wherein the storage medium is configured to store instructions;
the processor is configured to operate according to the instructions to implement the steps of the low-illumination image adaptive enhancement method according to claim 1.

10. A computer-readable storage medium, on which a computer program is stored, wherein the computer program, when executed by a processor, implements the low-illumination image adaptive enhancement method according to claim 1.
